(19) United States
(12) Patent Application Publication
(10) Pub. No.: US 2011/0008658 A1
(43) Pub. Date: Jan. 13, 2011

(54) ELECTRONIC DEVICE WITH SEALED BATTERY COMPARTMENT

(75) Inventors: Felix Holken, Morristown, NJ (US); Douglas Gardner, Dumont, NJ (US); Neil Olesen, Millington, NJ (US); Zbigniew Pobocha, Brookside, NJ (US)

Correspondence Address: STANDLEY LAW GROUP LLP, 6300 Riverside Drive, Dublin, OH, 43017, US

(73) Assignee: OHAUS CORPORATION, Pine Brook, NJ (US)

(21) Appl. No.: 12/834,481

(22) Filed: Jul. 12, 2010

Related U.S. Application Data
(60) Provisional application No. 61/224,697, filed on Jul. 10, 2009.

(51) Int. Cl. H01M 2/10; H01M 2/12

(52) U.S. Cl. 429/82

(57) ABSTRACT

A battery compartment and a battery-powered device utilizing the battery compartment. When installed to a battery-powered device, the battery compartment cavity and housed battery are maintained completely separate from the electronics of the battery-powered device. Therefore, a battery-powered device may be powered using a battery compartment of the present invention without concern that leaked electrolyte or emitted gas will enter the electronics portion of the device. A battery compartment of the present invention may also allow any built up electrolyte and/or gas to safely exit the battery compartment while simultaneously preventing or significantly inhibiting infiltration of the battery compartment by external substances.

### CROSS-REFERENCE TO RELATED APPLICATIONS

This application claims the benefit of U.S. Provisional Application No. 61/224,697, filed Jul. 10, 2009, which is hereby incorporated by reference as if fully recited herein.

### BACKGROUND OF THE INVENTIVE FIELD

The present invention is directed to a sealed battery compartment for use in an associated electronic device. More particularly, the present invention is directed to a sealed and separated battery compartment for use in an associated electronic device that is capable of preventing the transfer of battery fluids or gas between the battery compartment and an electronics section of the device.

A battery-powered device typically has an interior compartment for the electronic components and one or more batteries. Typically, these compartments are separated to prevent leaked electrolyte and/or expelled gas (e.g., hydrogen) from the battery from contacting the electronic components. As would be commonly understood by one of skill in the art, battery leaks may occur for various reasons. For example, electrolyte may leak due to the compromise of the battery casing over time. Hydrogen gas may be expelled during the normal battery discharge (use) or recharging processes.

As would also be commonly understood by one of skill in the art, leaked electrolyte can corrode metal components such as battery contacts, wiring, fasteners, etc. Leaked electrolyte can also damage or destroy electronic circuits and circuit components with which they come in contact. As hydrogen gas is flammable, a buildup of thereof could lead to a fire or explosion within a battery-powered device if ignited. Consequently, both the leakage of battery electrolyte and the buildup of hydrogen gas during battery discharge/recharge should be avoided.

### SUMMARY OF THE GENERAL INVENTIVE CONCEPT

The present invention is directed to a battery compartment that prohibits the transfer of electrolyte or gas to the electronics of an associated battery-powered device, and to a battery-powered device using such a battery compartment. The present invention is also directed to a battery compartment for use in a battery-powered device, wherein the design of the battery compartment limits the amount of any expelled substance from a battery that can accumulate in the battery compartment, and allows the free exit of any substance or pressure that accumulates in the battery compartment.

A battery compartment of the present invention is provided as a completely separate compartment within a battery-powered device. A battery compartment of the present invention is sealed from the electronics (e.g., electronics) compartment of the battery-powered device while still allowing electrical connections therebetween.

Such a design eliminates the possibility of substance transfer between the battery compartment and the electronics of the associated device, thereby protecting the electronic circuitry/components of the associated device. This design simultaneously permits leaked/emitted substances to exit the battery compartment to the exterior environment through exit grooves or similar structures, so as to prevent the buildup of unwanted gas and/or liquids within the battery compartment. A better understanding of the present invention can be gained from the following description of exemplary embodiments and the related drawing figures.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 is a front view of an exemplary battery housing portion of an exemplary battery compartment assembly of the present invention;

FIG. 2 is a bottom view of the battery housing of FIG. 1;

FIG. 3 is a side cross-sectional view of the battery housing of FIGS. 1-2;

FIG. 4 is an exploded perspective view of an exemplary electronic device having an exemplary battery compartment of the present invention installed thereto;

FIG. 5 is an enlarged cross-sectional right side view showing the electronic device and battery compartment of FIG. 4 in an assembled state; and

FIG. 6 is a rear perspective view of the electronic device of FIG. 5.

### DETAILED DESCRIPTION OF EXEMPLARY EMBODIMENT(S)

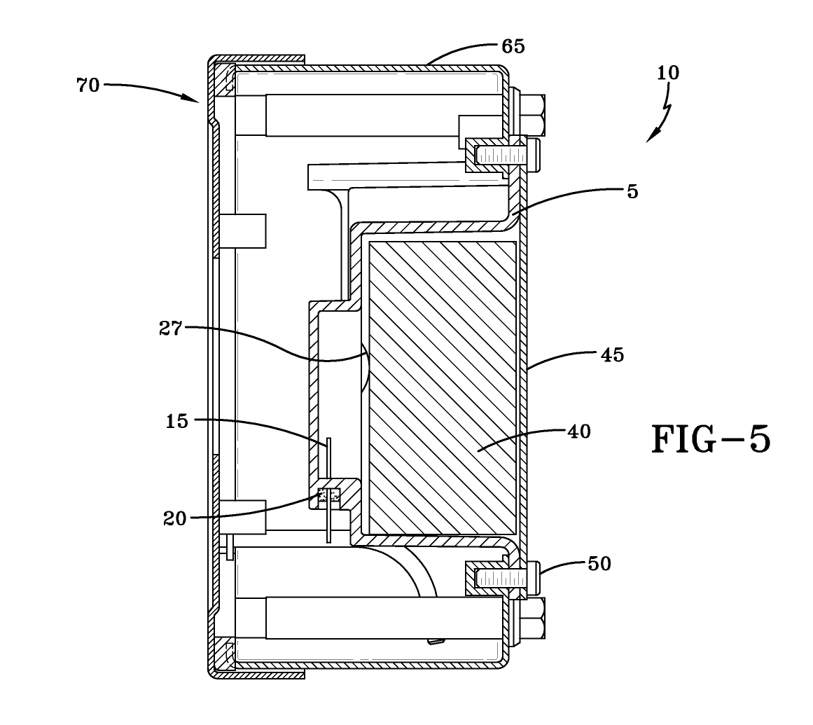

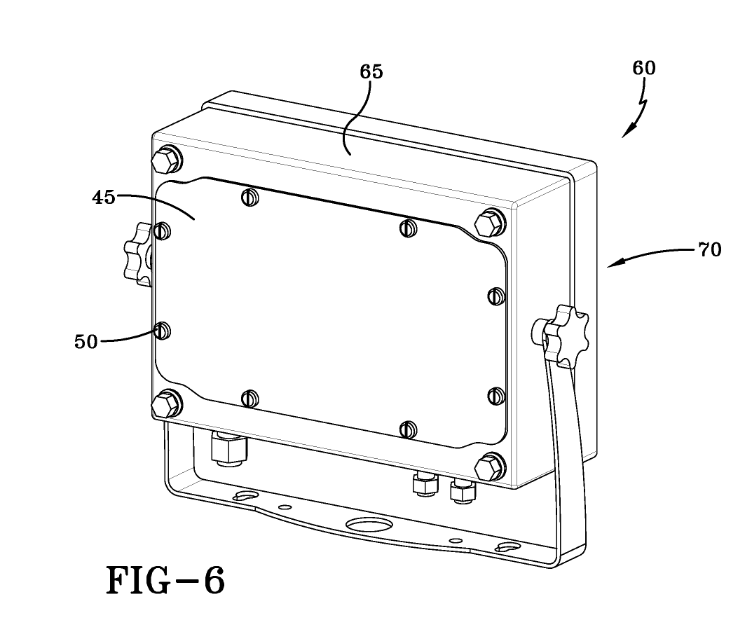

An exemplary housing portion 5 of an exemplary battery compartment 10 (see FIG. 5) of the present invention is illustrated in FIGS. 1-3. The housing 5 is shown to be a walled enclosure having a cavity 7 that functions to receive and house a battery when the battery compartment 10 is installed to a battery-powered device. The housing 5 may be constructed by a number of techniques but, preferably, is of molded construction. The housing 5 may be of various size and shape as dictated by the device into which it will be installed and the battery that it will hold. Typically, the housing 5 includes an opening 6 on at least one side to permit the insertion and removal of at least one battery.

In some embodiments, the cavity 7 may include a first portion 8 and a second portion 9, wherein the first portion 8 may be approximately the shape and dimensions of the battery that may be placed therein, so as to limit the amount of free space in which electrolyte or gas may accumulate. Preferably, but not essentially, the shape and dimensions of the housing interior (cavity) 7 are very similar to the shape and dimensions of the battery that will be placed therein. Furthermore, in some embodiments, the cavity 7 of the battery compartment 10 may house more than one battery, as some electronic devices may utilize multiple batteries during use.

Electrical contact between the electronics of an associated battery-powered device and a battery located in the housing 5 may be accomplished via electrical contacts 15 that extend through a wall of the housing 5. In some examples, the electrical contacts may be positioned to extend through a wall of the second portion 9 of the housing interior 7. The contacts 15 extend through the housing wall in a sealed manner, so as to prevent the entry of water or other liquid, gas or solid substances, and the exit of leaked electrolyte or hydrogen gas given off by a battery located within the housing. As would be readily apparent to one of skill in the art, these contacts may be provided in various number and may be of various design. For example, and without limitation, the contacts may be comprised of metallic tabs, encapsulated wires, etc.

Establishing a seal between the contacts 15 and the housing 5 may be accomplished by filling any voids between an aperture in the housing and the contacts passing therethrough with a sealing material 20 that is sufficiently resistant to any substances likely to be encountered. Alternatively, the housing 5 may be molded around the contacts 15 such that a seal therebetween is inherently created.

The battery housing 5 preferably contains means to permit the free exit of any substance (e.g., electrolyte or gas) that might build up in the cavity of the housing 5 after the housing is sealed to form a battery compartment (as described below). In this particular exemplary embodiment, this means comprises a number of grooves 25 that reside in a mounting flange 30 of the housing 5. The grooves 25 allow for the exit of electrolyte, gas, etc., from the housing cavity. Any suitable number of grooves 25 may be provided, and the grooves may be placed at various locations on the flange 30. Other means may also be provided for this purpose, such as breather vents, holes and channels of various shape and size.

When a groove or similar technique is used to permit the free exit of a substance from the housing cavity, the groove 25 is preferably provided with a labyrinth or other circuitous-type shape in order to minimize the entry of outside substances (e.g., water or other liquids) while simultaneously allowing an outflow of gas or leaked electrolyte. As would be understood by one of skill in the art, liquid materials may flow from the cavity by capillary action through such grooves, and gas may flow from a higher concentration to a lower concentration. A flow of material from the cavity may also be produced when the pressure inside the cavity exceeds that of the atmosphere outside the cavity (e.g., such as when gas is released within the cavity). The depicted grooves 25 and other such outflow material escape means may also be shaped and sized to permit gas outflow while limiting liquid transfer in both directions.

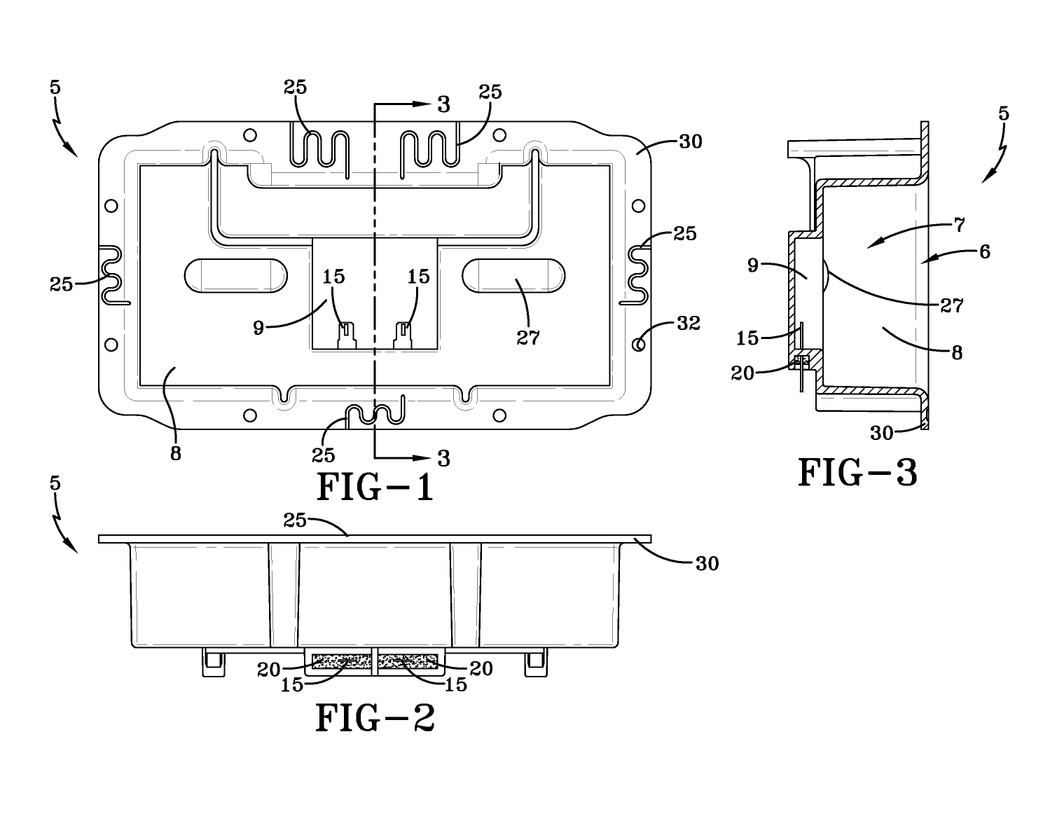

Protrusions or other raised surfaces 27 located on at least one of the interior walls of the housing 5 may facilitate the removal of unwanted gases or liquids that may accumulate therewithin by creating a gap between the interior walls of the housing and an installed battery, as best seen in FIG. 5. As seen in FIGS. 1 and 3, the raised surfaces 27 may be situated on a rear interior wall of the housing 5. However, in other embodiments, the raised surfaces may be situated on any number of interior surface walls of the housing 5 to promote the removal of unwanted gases or liquids.

An exemplary battery compartment 10 utilizing the battery compartment housing 5 is depicted in FIGS. 5 and 6 installed to a portion of an electronic device 60. The battery compartment 10 is shown to include the housing 5 having a cavity for holding a battery 40 in proper contacting position with the contacts 15, and a cover 45 adapted to be secured to the housing. Similar to the housing, the interior wall of the cover 45 may include at least one raised surface (not shown) to facilitate the removal of unwanted gases or liquids. In this example, the cover 45 is removably secured to the housing 5 with a plurality of fasteners 50. In alternate embodiments, other fastening means may be used, not all of which may allow for removal of the associated cover. For example, a disposable battery compartment could be produced, wherein a cover is permanently sealed to a housing. In any event, once the cover 45 is attached to the housing 5, a sealed battery compartment 10 is formed. An adhesive 55 or sealing element may be placed between the housing 5 and enclosure 65 to ensure a rigid connection and a proper seal therebetween. As seen in FIG. 1, the flange 30 may include one or more apertures 32 that facilitate the engagement between the housing 5 and the enclosure 65.

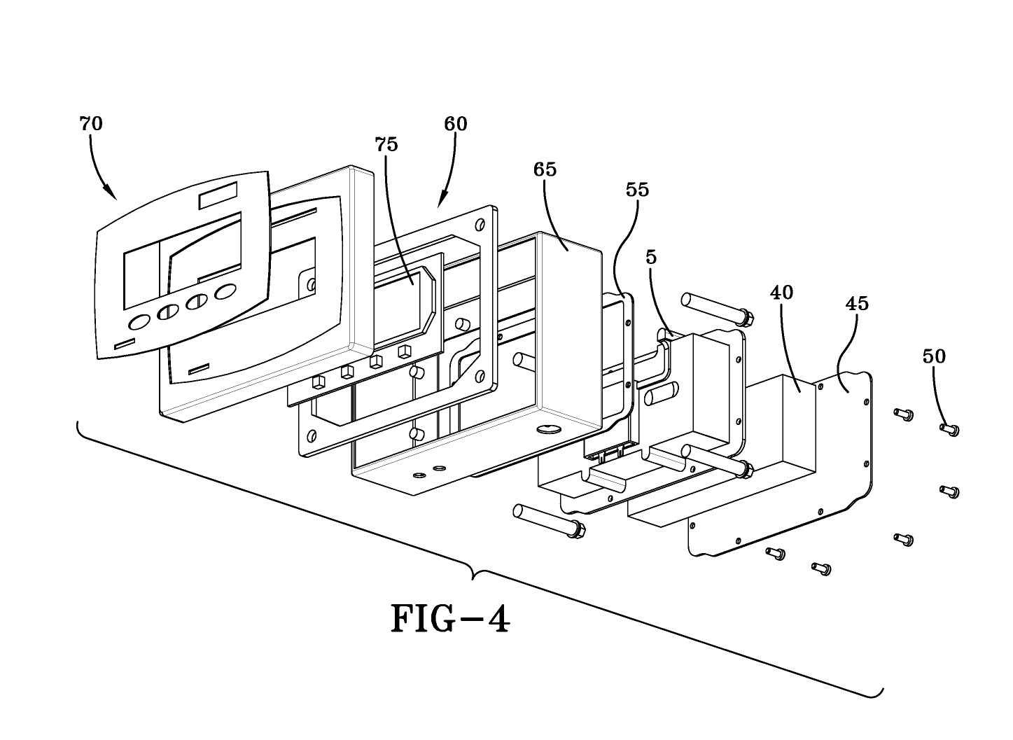

The exemplary battery-powered device 60 to which the battery compartment is installed in FIGS. 4-6 is an indicator of a weighing scale, although a battery compartment of the present invention is no way limited in application to such a device. The battery-powered device 60 is shown to include an enclosure 65 and a front panel section 70 that is adapted for attachment to the enclosure by a number of threaded fasteners. Electronic circuitry 75 is located within the enclosure 65.

As can be understood from the foregoing description and particularly from FIGS. 4-5, the battery compartment 10 and the battery 40 enclosed therein are completely separated from the electronic circuitry/components 75 of the electronic device 60 when the device is assembled. Because the electrical contacts 15 extend through the housing wall in a sealed manner, there is no leak path between the interior of the battery housing 5 and the electronic circuitry/components 75 of the electronic device 60. Electric power is supplied from the battery 40 to the electronic circuitry/components 75 of the electronic device 60 by appropriate connection thereof to the contacts 15 protruding from the electronic device side of the housing 5.

Therefore, it can be understood that a battery-powered device may be powered using a battery compartment of the present invention without concern that leaked electrolyte or emitted gas will enter the electronics portion of the device. It can also be understood that a battery compartment of the present invention allows any built up electrolyte and/or gas to safely exit the battery compartment while simultaneously preventing or significantly inhibiting infiltration of the battery compartment by external substances.

While certain exemplary embodiments are described in detail above for purposes of illustration, it would be apparent to one of skill in the art that changes may be made thereto without departing from the scope of the present invention. Therefore, the scope of the invention is not to be considered limited by such disclosure, and modifications are possible without departing from the spirit of the invention as evidenced by the following claims:

What is claimed is:

1. A battery compartment for use in a battery-powered device, said battery-powered device including electronic circuitry, said battery compartment comprising:
a walled housing forming a cavity for holding a battery of interest, said housing including an opening for insertion of a battery into said housing;
at least one contact extending in a sealed manner through a wall of said housing, one end of said at least one contact adapted for electrical communication with a battery placed in said housing, the other end of said contact adapted for electrical communication with electronic circuitry of a device to which said battery compartment is installed;
a cover adapted for attachment to said housing so as to seal said opening therein; and
means for allowing battery electrolyte and/or gas present in said cavity to escape therefrom once sealed, while simultaneously minimizing the opportunity for external substances to infiltrate said cavity.

2. The battery compartment of claim 1, wherein said housing cavity and a battery to be installed thereto are of substantially similar shape and dimensions so as to minimize the space in said housing in which electrolyte and/or gas may accumulate.

3. The battery compartment of claim 1, wherein said means for allowing battery electrolyte and/or gas present in said cavity to escape comprise grooves that lead from said cavity to the exterior of said housing.

4. The battery compartment of claim 3, wherein said grooves follow a circuitous path that inhibits infiltration of said housing cavity by external substances.

5. The battery compartment of claim 1, wherein said means for allowing battery electrolyte and/or gas present in said cavity to escape resides in a mounting flange of said housing.

6. The battery compartment of claim 1, further comprising at least one raised surface on an interior wall of said housing that creates a gap between said interior wall of said housing and said installed battery.

7. The battery compartment of claim 1, wherein said walled housing includes a first portion that forms said cavity for holding said battery of interest, and a second portion wherethru said at least one contact extends in a sealed manner through a wall thereof.

8. A battery compartment for use in a battery-powered device, said battery-powered device including electronic circuitry, said battery compartment comprising:
a walled housing forming a cavity for holding a battery of interest, said housing including an opening for insertion of a battery into said housing;
at least one contact extending in a sealed manner through a wall of said housing, one end of said at least one contact adapted for electrical communication with a battery placed in said housing, the other end of said contact adapted for electrical communication with electronic circuitry of a device to which said battery compartment is installed;
a cover adapted for attachment to said housing so as to seal said opening therein; and
at least one groove that leads from said cavity to the exterior of said housing and allows battery electrolyte and/or gas present in said cavity to escape therefrom once sealed, while simultaneously minimizing the opportunity for external substances to infiltrate said cavity.
wherein said housing cavity and a battery to be installed thereto are of substantially similar shape and dimensions so as to minimize the space in said housing in which electrolyte and/or gas may accumulate.

9. The battery compartment of claim 8, wherein said grooves follow a circuitous path that inhibits infiltration of said housing cavity by external substances.

10. The battery compartment of claim 8, wherein said at least one groove resides in a mounting flange of said housing.

11. The battery compartment of claim 8, further comprising at least one raised surface on an interior wall of said housing that creates a gap between said interior wall of said housing and said installed battery.

12. The battery compartment of claim 8, wherein said walled housing includes a first portion that forms said cavity for holding said battery of interest, and a second portion wherethru said at least one contact extends in a sealed manner through a wall thereof.

13. A battery-powered device having an enclosure, said enclosure containing electronic circuitry and a battery compartment having a cavity for holding a battery, said cavity separated from said electronic circuitry, said battery compartment comprising:
a walled housing forming a cavity for holding a battery of interest, said housing including an opening for insertion of a battery into said housing;
at least one contact extending in a sealed manner through a wall of said housing, one end of said at least one contact adapted for electrical communication with a battery placed in said housing, the other end of said contact adapted for electrical communication with electronic circuitry of a device to which said battery compartment is installed;
a cover adapted for attachment to said housing so as to seal said opening therein; and
means for allowing battery electrolyte and/or gas present in said cavity to escape therefrom once sealed, while simultaneously minimizing the opportunity for external substances to infiltrate said cavity.

14. The battery-powered device of claim 13, wherein said battery compartment housing cavity and a battery to be installed thereto are of substantially similar shape and dimensions so as to minimize the space in said housing in which electrolyte and/or gas may accumulate.

15. The battery-powered device of claim 13, wherein said means for allowing battery electrolyte and/or gas present in said battery compartment housing cavity to escape comprises grooves that lead from said cavity to the exterior of said housing.

16. The battery-powered device of claim 15, wherein said grooves follow a circuitous path that inhibits infiltration of said housing cavity by external substances.

17. The battery-powered device of claim 13, further comprising at least one raised surface on an interior wall of said battery compartment housing that creates a gap between said interior wall of said housing and said installed battery.

18. The battery-powered device of claim 13, wherein said walled battery compartment housing includes a first portion that forms said cavity for holding said battery of interest, and a second portion through which said at least one contact extends in a sealed manner through a wall thereof.

19. The battery-powered device of claim 13, further comprising an adhesive element that is adapted to be placed between said battery compartment housing and said enclosure.

20. The battery-powered device of claim 13, wherein said means for allowing battery electrolyte and/or gas present in said battery compartment housing cavity to escape resides in a mounting flange of said housing.
